(19) United States
(12) Patent Application Publication
(10) Pub. No.: US 2026/0326016 A1
(43) Pub. Date: Oct. 22, 2026

(54) VERTICAL FLOW QUAD-BED DRY MEDIA SCRUBBER FOR ODOR CONTROL

(71) Applicants: Evoqua Water Technologies LLC, Pittsburgh, PA (US); Evoqua Water Technologies Canada Ltd., Fredericton (CA)

(72) Inventors: Sean F. Trainor, Milwaukee, WI (US); Devang N. Pujara, San Marcos, CA (US); Bryan D. Haan, Strathroy (CA)

(21) Appl. No.: 18/993,166

(22) PCT Filed: Jul. 17, 2023
(86) PCT No.: PCT/US2023/027880

§ 371 Date: Jan. 10, 2025

Related U.S. Application Data
(60) Provisional application No. 63/390,097, filed on Jul. 18, 2022.

(51) Int. Cl. B01D 53/04; B01D 53/82

(52) U.S. Cl. CPC B01D 53/0423; B01D 53/82; B01D 2257/90; B01D 2258/06

(57) ABSTRACT

A vertical flow dry media scrubber comprises four vertically aligned dry media beds and air plenums alternately disposed above and below each of the four vertically aligned dry media beds. The plurality of air plenums include contaminated air plenums including contaminated air inlets positioned in the walls of a lowermost one of the contaminated air plenums and an uppermost one of the contaminated air plenums, respectively, and treated air plenums including treated air outlets positioned in the walls of a lowermost one of the treated air plenums, an uppermost one of the treated air plenums, and a centrally located one of the treated air plenums, respectively, the treated air plenums disposed on vertically opposite sides of one of the contaminated air plenums, the contaminated air plenums disposed on vertically opposite sides of one of the treated air plenums.

### CROSS-REFERENCE TO RELATED APPLICATIONS

The present application is a U.S. national stage of PCT/US2023/027880 filed Jul. 17, 2023, titled “Vertical Flow Quad-Bed Dry Media Scrubber for Odor Control”, which claims priority to U.S. Provisional Patent Application 63/390,097 filed Jul. 18, 2022, titled “Vertical Flow Quad-Bed Dry Media Scrubber for Odor Control”, the disclosures of which are incorporated herein by reference in their entirety.

### BACKGROUND

### 1. Field of Invention

Aspects and embodiments disclosed herein relate to a dry media scrubber for odor control and, more specifically, a vertical flow quad-bed dry media scrubber.

### 2. Discussion of Related Art

Sewage systems typically include conduits that collect and direct sewage and other waste streams, such as industrial effluents, to a treatment facility. Such systems typically include various pumping facilities, such as lift stations, that facilitate the transfer of wastewater to such treatment facilities. During transit odorous species are often generated. Such odorous species may be objectionable when released or discharged. Untreated sewage and wastewater treatment processes may generate multiple odor-causing compounds. One of the most prevalent and most distinctive compounds formed is hydrogen sulfide (H₂S). Other objectionable or odor-causing compounds from contaminated air streams may include compounds resulting from the volatilization of reduced sulfur compounds in a sewage or wastewater stream such as any one or more of carbon disulfide, dimethyl sulfide, dimethyl disulfide, dimethyl trisulfide, methyl mercaptans, ethyl mercaptans, butyl mercaptans, allyl mercaptans, propyl mercaptans, crotyl mercaptans, benzyl mercaptans, thiophenol, sulfur dioxide, and carbon oxysulfide.

### SUMMARY

In accordance with an aspect of the present invention, there is provided a vertical flow dry media scrubber. The media scrubber comprises four vertically aligned dry media beds and a plurality of air plenums alternately disposed above and below each of the four vertically aligned dry media beds. The plurality of air plenums include at least two contaminated air plenums each including contaminated air inlets positioned in walls thereof, wherein the contaminated air inlets are positioned in the walls of a lowermost one of the at least two contaminated air plenums and an uppermost one of the at least two contaminated air plenums, respectively, and at least two treated air plenums each including treated air outlets positioned in walls thereof, the at least two treated air plenums disposed on vertically opposite sides of one of the at least two contaminated air plenums, the at least two contaminated air plenums disposed on vertically opposite sides of one of the at least two treated air plenums, the treated air outlets positioned in the walls of a lowermost one of the at least two treated air plenums, an uppermost one of the at least two treated air plenums, and a centrally located one of the at least two treated air plenums, respectively.

In some embodiments, the media scrubber is further configured to direct contaminated air from a first of the contaminated air inlets through the uppermost one of the at least two contaminated air plenums and an uppermost one of the four vertically aligned dry media beds into the uppermost of the at least two treated air plenums as well as through the uppermost one of the at least two contaminated air plenums and a second to highest one of the four vertically aligned dry media beds into the centrally located one of the at least two treated air plenums.

In some embodiments, the media scrubber is configured to direct contaminated air from a second of the contaminated air inlets through the lowermost one of the at least two contaminated air plenums and a lowermost one of the four vertically aligned dry media beds into the lowermost one of the at least two treated air plenums as well as through the lowermost one of the at least two contaminated air plenums and a second to lowest one of the four vertically aligned dry media beds into the centrally located one of the at least two treated air plenums.

In some embodiments, the centrally located one of the at least two treated air plenums has a greater height than the lowermost one of the at least two treated air plenums.

In some embodiments, the treated air outlet positioned in the wall of centrally located one of the at least two treated air plenums has a greater cross-sectional area than each of the treated air outlet positioned in the wall of the lowermost one of the at least two treated air plenums and the treated air outlet positioned in the wall of the uppermost one of the at least two treated air plenums.

In some embodiments, each of the four vertically aligned dry media beds include screens defined in lower portions thereof, the screens configured to support and retain dry media within each of the four vertically aligned dry media beds.

In some embodiments, the media scrubber further comprises ring baffles disposed on upstream ends of each of the four vertically aligned dry media beds adjacent outer sidewalls of the four vertically aligned dry media beds.

In some embodiments, the contaminated air inlets are fluidically coupled to a same contaminated air inlet header.

In some embodiments, the media scrubber further comprises media bed separators disposed in each of the four vertically aligned dry media beds which separate each of the four vertically aligned dry media beds into at least two vertically separated sub-beds.

In some embodiments, the media scrubber further comprises access panels defined in an outer wall of the media bed scrubber above each respective one of the four vertically aligned dry media beds, the access panels positioned and arranged to provide for dry media to be introduced into and removed from each respective one of the four vertically aligned dry media beds.

In accordance with another aspect, there is provided a method of removing one or more undesirable compounds from contaminated air. The method comprises introducing a first portion of the contaminated air into a first contaminated air plenum of a vertical flow dry media scrubber through a first contaminated air inlet at a pressure and velocity sufficient to pass contaminated air from the first contaminated air plenum through a first dry media bed into a first treated air plenum and to pass the contaminated air from the first contaminated air plenum through second dry media bed that is vertically displaced from the first dry media bed and into a second treated air plenum, introducing a second portion of the contaminated air through a second contaminated air inlet into a second contaminated air plenum of the vertical flow dry media scrubber at a pressure and velocity sufficient to pass contaminated air from the second contaminated air plenum through a third dry media bed that is vertically displaced from the first and second dry media beds into a third treated air plenum that is vertically displaced from the first and second treated air plenums and to pass contaminated air from the second contaminated air plenum through a fourth dry media bed that is vertically displaced from the first, second, and third dry media beds and into the first treated air plenum, the first treated air plenum disposed between the first dry media bed and the fourth dry media bed, and withdrawing treated air from the first, second, and third treated air plenums, treated air being withdrawn from the first treated air plenum at a flowrate of about twice a flowrate at which treated air is withdrawn from each of the second and third treated air plenums.

In some embodiments, the contaminated air is introduced into the first and second contaminated air plenums at a same flow rate.

In some embodiments, withdrawing treated air from the first, second, and third treated air plenums includes withdrawing treated air from the first treated air plenum through a treated air outlet having a greater cross-sectional area than treated air outlets through which treated air is withdrawn from either the second or third treated air plenum.

In some embodiments, passing the contaminated air through the first, second, third, and fourth dry media beds includes passing the contaminated air through a same media in each of the first, second, third, and fourth dry media beds.

In some embodiments, passing the contaminated air through the first, second, third, and fourth dry media beds includes passing the contaminated air through a first type of media and a second type of media in a same order in each of the first, second, third, and fourth dry media beds.

In accordance with another aspect, there is provided a method of removing at least one undesirable compound from contaminated air. The method comprises introducing a first portion of the contaminated air into a first contaminated air plenum of a vertical flow dry media scrubber through a first contaminated air inlet at a pressure and velocity sufficient to pass contaminated air from the first contaminated air plenum through a first dry media bed into a first treated air plenum, introducing a second portion of the contaminated air into a second contaminated air plenum of the vertical flow dry media scrubber that is vertically displaced from the first contaminated air plenum through a second contaminated air inlet at a pressure and velocity sufficient to pass contaminated air from the second contaminated air plenum through a second dry media bed that is vertically displaced from the first dry media bed into the first treated air plenum and through a third dry media bed that is vertically displaced from the first and second dry media beds into a second treated air plenum, and introducing a third portion of the contaminated air into a third contaminated air plenum of the vertical flow dry media scrubber that is vertically displaced from the first and second contaminated air plenums through a third contaminated air inlet at a pressure and velocity sufficient to pass contaminated air from the third contaminated air plenum through a fourth dry media bed that is vertically displaced from the first, second, and third dry media beds into the second treated air plenum, wherein the contaminated air is introduced into the second contaminated air plenum at a flow rate approximately twice that of a flow rate at which the contaminated air is introduced into either of the first and third contaminated air plenums.

In accordance with another aspect, there is provided a vertical flow dry media scrubber. The scrubber comprises four vertically aligned dry media beds and a plurality of air plenums each alternately disposed above and below each of the four vertically aligned dry media beds. The plurality of air plenums include at least two contaminated air plenums each including contaminated air inlets positioned in walls thereof, and at least two treated air plenums each including treated air outlets positioned in walls thereof, the at least two treated air plenums disposed on vertically opposite sides of one of the at least two contaminated air plenums, the at least two contaminated air plenums disposed on vertically opposite sides of one of the at least two treated air plenums.

In accordance with another aspect, there is provided a vertical flow dry media scrubber. The media scrubber comprises four vertically aligned dry media beds, and a plurality of air plenums each alternately disposed above and below each of the four vertically aligned dry media beds. The plurality of air plenums include at least two contaminated air plenums each including contaminated air inlets positioned in walls thereof and at least two treated air plenums disposed on vertically opposite sides of one of the at least two contaminated air plenums, the at least two contaminated air plenums disposed on vertically opposite sides of one of the at least two treated air plenums. The media scrubber further includes internal air transfer ducts passing through the four vertically aligned dry media beds and providing for flow of treated air between each of the at least two treated air plenums.

In some embodiments, the media bed scrubber includes a single treated air outlet defined in a wall of one of the at least two treated air plenums and in fluidic communication with each of the at least two treated air plenums.

In some embodiments, one of the internal air transfer ducts passes through two of the four vertically aligned dry media beds and provides for airflow between two of the at least two treated air plenums and a second of the internal air transfer ducts passes through two other of the four vertically aligned dry media beds and provides for airflow between two others of the at least two treated air plenums

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic cross-sectional illustration of a vertical flow quad bed dry media scrubber system;

FIG. 2 is another schematic cross-sectional illustration of a vertical flow quad bed dry media scrubber system;

FIG. 3 illustrated stacked media beds which may be utilized in embodiments of vertical flow quad bed dry media scrubber systems as disclosed herein;

FIG. 4 is a schematic cross-sectional illustration of another embodiment of a vertical flow quad bed dry media scrubber system; and

FIG. 5 is a schematic cross-sectional illustration of another embodiment of a vertical flow quad bed dry media scrubber system.

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

In wastewater treatment systems, various undesirable chemical species may be generated, as discussed in the background section. Hydrogen sulfide (H₂S) is an example of such a species. Hydrogen sulfide is generated in some wastewater collection and treatment systems and is considered an undesirable byproduct. Even small concentrations of H₂S can negatively impact the air quality in the vicinity of a wastewater treatment plant or other components of a wastewater treatment system.

It is generally desirable to remove hydrogen sulfide from air streams from sewage systems, manhole headspaces, wastewater treatment systems, and/or other systems in which hydrogen sulfide may be generated. Aspects and embodiments disclosed herein include systems and methods for removing hydrogen sulfide from contaminated air streams. Aspects and embodiments disclosed herein may also be utilized to remove other objectionable and/or odor causing compounds from contaminated air streams, for example, compounds resulting from the volatilization of reduced sulfur compounds in a sewage or wastewater stream such as any one or more of carbon disulfide, dimethyl sulfide, dimethyl disulfide, dimethyl trisulfide, methyl mercaptans, ethyl mercaptans, butyl mercaptans, allyl mercaptans, propyl mercaptans, crotyl mercaptans, benzyl mercaptans, thiophenol, sulfur dioxide, and carbon oxysulfide, or hydrogen sulfide generated from any of these compounds by sulfate reducing bacteria. For the sake of simplicity, however, aspects and embodiments disclosed herein will be described as removing hydrogen sulfide from contaminated gas streams.

When designing or selecting an activated carbon or dry media odor control system, there are two particularly important components to consider-the media and the vessel. Referring specifically to vessels, each major vessel design has advantages and disadvantages that are important to understand to ensure that the most suitable vessel design is utilized for a particular odor control application. Materials of construction of these vessels is also important, as this can drastically impact the lifespan of an installation, especially when hydrogen sulfide gas is present.

Activated carbon filters are arguably the least complex and most commonly utilized form of vapor phase odor control technology used for municipal and industrial applications. The filters comprise a vessel and a media that is selected to adsorb or react with the compounds of concern. There may be some additional equipment, such as, e.g., a fan or a pre-filter, but in general, the vessel and media effectively treat odors with minimal maintenance until the media is consumed and in need of replacement. Due to this simplicity, activated carbon filters are a very frequently utilized technology and, in the correct application, are a very effective odor control solution.

Activated carbon has been used for controlling sewer odors for well over a century. Various advancements in medias and applications in recent decades have drastically improved the capabilities of this technology to cost-effectively keep odors at bay.

Despite these advancements, activated carbon systems still have a limited capacity for some of the most common odorous compounds of concern such as ammonia and hydrogen sulfide. However, they can be very effective for low concentrations of these compounds and for broad spectrum odor treatment where a large range of compounds are contributing to the odors. As such, although frequently used alone, activated carbon systems are often implemented as a polishing stage following another technology such as, e.g., biotrickling filters or chemical scrubbers.

The generic terms ‘activated carbon’ and ‘dry media’ are used to describe a range of medias used in this type of technology, i.e., pelletized, granular, or spherical dry media designed to absorb or destroy odorous compounds. There are a variety of medias used in odor control systems depending on the compounds to be treated. These include virgin activated carbons, manufactured from coal, coconut or wood, used primarily for hydrogen sulfide and organic odor compounds, high capacity or catalytic activated carbons that have higher capacity for hydrogen sulfide but may have reduced capacity for some organics, and chemically impregnated medias where a reactant is impregnated onto the activated carbon or another base material such as zeolite or alumina. Caustic compounds (sodium hydroxide, potassium hydroxide or potassium iodide) historically have been used for hydrogen sulfide removal. Acidic compounds (e.g., phosphoric acid) are used for ammonia and amine treatment. Oxidizing compounds (e.g., potassium permanganate) provide effective final polishing for difficult to treat compounds. These medias can be combined to efficiently treat specific odor sources. In some implementations it may be best to layer these medias to allow each media to focus on the target compounds. For example, although potassium permanganate impregnated media can destroy most odorous compounds, it has a limited capacity. As such, one may install a layer of virgin activated carbon to adsorb the majority of the odorous compounds. This is then followed with a layer of potassium permanganate impregnated zeolite to act as the final polishing step.

While media selection is important to a successful activated carbon odor control system, the design of the vessel holding the media is of equal importance. Materials of construction, sizing, and flow configuration will affect the performance and longevity of the system.

Three major groups of materials are typically used in the manufacture and construction of vessels for odor control activated carbon vessels—metals, concrete and plastics.

For metal vessels, in less corrosive or short-term applications, epoxy coated steel may be suitable. Stainless steel vessels can have a longer life in corrosive odor control applications. However, quality control in fabrication is important to prevent premature corrosion.

Historically used in large, single bed carbon systems, reinforced concrete is a relatively expensive choice for an odor control vessel, as a full sealed liner is needed to prevent corrosion. Cast-in high density polyethylene (HDPE) liners are recommended over spray-on liners due to erosion potential.

The most common materials of manufacture for odor control vessels are plastics. In smaller systems, HDPE is commonly utilized. Due to limitations in the structural and dimensional properties of HDPE, this material is not commonly used for larger vessels. A premium material for activated carbon filters is glass reinforced plastic (also known as GRP, fiberglass, or FRP). Appropriately maintained vessels manufactured by high quality fabricators using premium vinyl ester resins can exceed 25 years in life.

The two most important process parameters for sizing an activated carbon odor control system are Empty Bed Residence Time (EBRT) and Bed Face Velocity. These two parameters determine the number and dimensions of the activated carbon beds around which the vessels are designed. Typical EBRT for a municipal odor control application starts from ~2.5 seconds for a polishing application. For a primary odor control application, the EBRT is typically ~3 seconds, and up to 3.5 seconds may be specified for implementations using multiple layered medias.

The ideal bed face velocity to balance pressure drop and media life ranges from 0.25 meters per second [m/s] (50 feet per minute [FPM]) up to 0.375 m/s (~75 FPM). Velocities as low as 0.15 m/s (~30 FPM) are acceptable, especially with granular medias. To achieve optimal media life, bed velocity should remain relatively constant throughout the cross-section of the bed.

The above design parameters have led to a typical system design of a 0.9 m (3 ft) deep bed operating at 0.3 m/s (60 FPM) resulting in 3 seconds EBRT.

Physical considerations such as footprint and access requirements may also impact the design. Additional process parameters that may be taken into consideration are media life and pressure drop, but these are generally secondary considerations that are impacted by media selection and vessel selection.

Both vertical flow and horizontal flow vessel designs are utilized, with each design having its advantages and disadvantages. Vertical flow designs are most common for cylindrical vessels and large deep bed tanks. They allow for simpler construction and flexibility in layering medias on top of each other. Horizontal flow designs can result in longer media life due to better moisture management but require a support structure on each side of the media bed(s), potentially leading to higher capital cost. Multi-layered horizontal flow systems can be designed to allow replacement of individual media layers, which is useful when a particular media layer requires more frequent changeout.

Vertical flow single bed systems are the most common and simplistic of activated carbon system designs. They generally allow easy media changeout and have good moisture management when operated in an up-flow arrangement. The main downsides of this design are inefficient footprint usage and higher capital cost compared to some other designs. Cylindrical vessel construction is most common, but square or rectangular designs are also utilized.

Horizontal flow single bed systems are sometimes used in lower flow, multi-layered media implementations.

Vertical flow dual-bed systems are the next most common design and can handle up to double the flow of their single bed cousins for a particular footprint, with a 4.25 m (~14 ft) diameter vessel treating around 35,000 meter cubed per hour [m³/h] (20,600 cubic feet per minute[CFM]). They are also taller than a single bed system, which can be positive for dispersion, but increases working height for media changeouts. Flow enters from the side of the vessel and then splits between the upper and lower beds. The air from the lower bed either exits out the side near the bottom of the vessel and is ducted to an external stack or is exhausted up though the interior of the vessel via an internal stack. The internal stack is the most common design as it reduces the overall vessel height. However, it is important to note that the internal stack takes away from cross-sectional area of both beds, reducing the EBRT and hence the flow capacity of the system. Vertical flow dual-bed systems may face challenges with moisture management, as most of the moisture entering the system ends up in the lower bed, potentially resulting in uneven media life between the two beds. Media changeout is also more complex than in a single-bed system, especially for the lower bed.

For a medium flow lower profile application, a parallel dual-bed design may be suitable. A vessel of square cross-section with dimensions of 4.25 m (~14 ft) can treat up to 40,000 m³/h(~23,500 CFM). This design will be more expensive capital-wise than a vertical flow dual-bed but is better for moisture management and allows for layered media separated by intermediate dividers.

A subset of horizontal flow dual-bed, V-banks are a very effective high flow design solution, with individual factory-built vessels capable of greater than 110,000 m³/h (~65,000 CFM). The V-bank design, per its name, incorporates two horizontal flow beds arranged in a V-shape. In one variation air enters the ‘top’ of the Vee at one end of the vessel, travels through the media bed to the outer plenum and exhausts at the opposite end of the vessel. In another variation, the air travels in the opposite direction through the vessel and media bed. Media access is via multiple roof hatches along the length of the beds. The roof is flat and can be outfitted with stairs and handrails for easy and safe access. Since there is no side access required and ductwork is located at the ends of the vessels, vessels can be located adjacent to each other for air flows exceeding the capacity of a single vessel. For large odor control installations, V-banks are generally an appealing vessel design. For example, in one installation, 18-qty cylindrical vertical flow dual-bed vessels of 4 m (~13 ft) diameter were replaced with 5-qty V-bank vessels. This design drastically reduced the complexity of ductwork, dampers, instrumentation, piping and steelwork. A 30% footprint reduction was realized, operations and maintenance improvements from both cost and safety criteria were identified, as were significant savings in installation cost and schedule.

As suggested by the name, horizontal quad bed systems incorporate 4 vertical media beds. Cylindrical quad bed units are capable of handling up to 70,000 m³/h (~41,000 CFM). The inlet ductwork splits the flow, and the air enters through two locations on the side of the vessel, with the flow then distributed equally among the 4 beds. There are 3 outlets on the opposite side of the vessel with one taking the flow from two beds and the others each exhausting the flow from one bed. These outlets are typically combined to a common stack. Despite these vessels being quite compact in size, due to the complex ductwork, the installed footprint is not as compact as often initially assumed.

Radial flow designs are cylindrical vessels that incorporate a donut/annulus-type media bed. The flow enters the vessel side, distributes around the outer annulus plenum, and travels horizontally through the media bed to the center of the annulus. From there, the air travels vertically up the central void and exits the vessel out a top central nozzle. This type of system has seen some popularity in locations where minimizing footprint is the primary criteria. However, the annular media bed does result in some limitations. As the air flows from the outside of the donut-shaped bed to the center of the donut, the cross-sectional area changes dramatically. This results in low face velocity as the air enters the media bed and a much higher bed face velocity at the center. Compared to the other designs described herein where the face velocity remains constant throughout the bed depth, radial flow systems must be designed for a very specific flowrate and leave very little flexibility in operating range. Additionally, these annular media beds often exceed 20 ft in height. Such a bed height has raised some concerns about crushing of media in the lower portion of the media bed, especially if upstream moisture management is ignored. Some facilities have also experienced challenges with safely performing media changeouts from the relatively small top access hatches or undertaking maintenance activities such as retaining screen repair/replacement.

Aspects and embodiments disclosed herein pertain to a vertical flow quad-bed system which may overcome at least some of the performance, flexibility, and maintenance challenges of other vessel media bed arrangements. At least some of the challenges of the other vessel media bed arrangements (e.g., the radial flow design) that are overcome by this invention include variable face velocity through the media bed resulting in sub-optimal media life, annulus-shaped media bed resulting in difficulty with layering of medias for broad-spectrum odor removal, media crushing due to height of media bed, and-restricted/difficult media installation/changeout and vessel access for repairs.

The vertical flow quad-bed design in accordance with aspects and embodiments disclosed herein includes some features of both the vertical flow dual-bed and the horizontal flow quad-bed or quad-bank designs, and creates a high flow capacity, small footprint solution while substantially avoiding the technical limitations of other vessel designs such as, e.g., the radial flow activated carbon vessel design.

Each bed is supported on a structure typically including beams, grating, and media-retaining screens. The air is fed into the vessel via two inlet flanges/nozzles located on the vessel wall(s). Inlet #1 is located in the void between beds #1 and #2. Inlet #2 is located in the void between beds #3 and #4. The air passes through the media beds, resulting in removal/destruction/conversion of odorous compounds. The air then exits the vessel through, e.g., three (3) outlets located on the vessel wall(s). The outlets may be located in the voids on the opposite sides of the media beds to the voids in which the inlets are located, with ~50% of air passing through one outlet nozzle and ~25% of air passing through the other outlet nozzles. Internal stacks/air transfer ducts could also be used to move treated air to different void compartments within the vessel to allow for air to be exhausted through one or more stacks/outlet nozzles. Outlet nozzles can then be ducted to a common stack.

The vessel may include access hatches to enable installation/loading and changeout of media, and to facilitate internal maintenance. Additionally, ancillary equipment to support operation of this system may include, e.g., fan(s), grease filter/mist eliminators, dampers, sample ports, differential pressure gauges and/or transmitters, media bed monitoring systems, gas monitoring systems (e.g., for CO, or inlet/outlet gas composition), bed temperature monitoring systems, heat fire suppression systems (water or other).

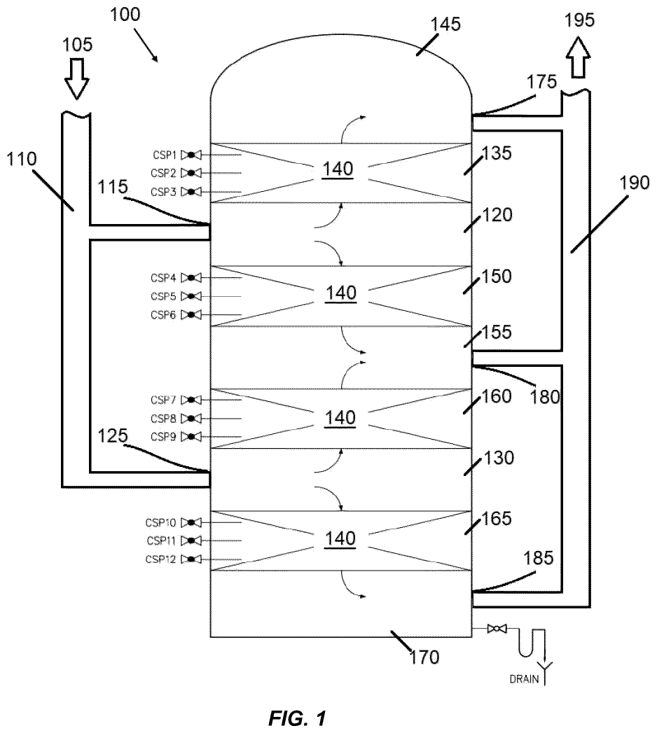

Referring to FIG. 1, a vertical cylindrical vessel 100 containing four (4) activated carbon/dry media beds 135, 150, 160, 165 in accordance with an aspect of the present disclosure is shown. These beds fill the cross-section of the vessel 100, forcing any air travelling vertically through the vessel to pass though one of the beds 135, 150, 160, 165. It is to be understood that bed height may vary based on specific application. The vessel could also be a square or rectangular vessel. The vessel 100 includes two contaminated air plenums 120, 130 and three treated air plenums 145, 155, 170. Each of the three treated air plenums 145, 155, 170 are disposed on vertically opposite sides of one of the two contaminated air plenums 120, 130. Each of the two contaminated air plenums 120, 130 are disposed on vertically opposite sides of two of the three treated air plenums 145, 155, 170. Specifically, contaminated air plenum 120 is disposed below an uppermost of the treated air plenums 145 and above a centrally located one of the treated air plenums 155 and contaminated air plenum 130 is disposed above a lowermost of the treated air plenums 170 and below the centrally located one of the treated air plenums 155.

Contaminated air 105 is provided to the vessel 100 from a contaminated air header 110. A first portion of the contaminated air 105 flows through a first or upper contaminated air inlet 115 into a first or upper (or uppermost) contaminated air plenum 120. A second portion of the contaminated air 105 flows through a second or lower contaminated air inlet 125 into a second or lower (or lowermost) contaminated air plenum 130. Contaminated air 105 may flow through the two contaminated air inlets 115, 125 and into the two contaminated air plenums 120, 130 at the same or approximately the same rate which may be controlled by a fan pushing the contaminated air 105 through the contaminated air header 110 upstream of the vessel 100 and/or by a fan pulling treated air through a treated air header 190 downstream of the vessel 100 and/or by one or more valves (not shown for clarity) located in the contaminated air inlets 115, 125.

Contaminated air 105 from the uppermost contaminated air plenum 120 splits into two streams. One of the contaminated air streams from the uppermost contaminated air plenum 120 passes through an uppermost one of the four vertically aligned dry media beds 135 in which one or more contaminants are removed from the contaminated air depending on the type of dry media 140 included in the dry media bed 135 to form treated air 195. The treated air 195 passes from the uppermost dry media bed 135 into an uppermost of the treated air plenums 145. The second of the contaminated air streams from the uppermost contaminated air plenum 120 passes through a second to highest one of the dry media beds 150 to form treated air which flows from the second to highest one of the dry media beds 150 into the centrally located treated air plenum 155.

Contaminated air 105 from the lowermost contaminated air plenum 130 splits into two streams. One of the contaminated air streams from the lowermost contaminated air plenum 130 passes through a lowermost one of the four vertically aligned dry media beds 140 to form treated air which flows from the lowermost one of the dry media beds 140 into a lowermost one of the treated air plenums 170. The second of the contaminated air streams from the lowermost contaminated air plenum 130 passes through a second to lowest one of the dry media beds 160 to form treated air which flows from the second to lowest one of the dry media beds 160 into the centrally located treated air plenum 155.

The treated air 195 flows though outlets 175, 180, 185 positioned in the walls of the treated air plenums 145, 155, 170, respectively, into a treated air manifold 190, from which it is released to the environment or sent to a further downstream treatment operation.

The centrally located treated air plenum 155 receives air from both the uppermost contaminated air plenum 120 and lowermost contaminated air plenum 130 through both the second to highest and second to lowest dry media beds 150, 160, respectively. The uppermost treated air plenum 145 receives air from only the uppermost contaminated air plenum 120 through the uppermost dry media bed 135 and the lowermost treated air plenum 170 receives air from only the lowermost contaminated air plenum 130 through the lowermost dry media bed 165. Accordingly, the centrally located treated air plenum 155 receives about twice as much air as the uppermost treated air plenum 145 and the lowermost treated air plenum 170. To accommodate this greater air flow the centrally located treated air plenum 155 may have a greater height than the uppermost treated air plenum 145 and/or the lowermost treated air plenum 170, for example, a height of a bout twice that of the uppermost treated air plenum 145 and/or the lowermost treated air plenum 170. In embodiments in which the uppermost treated air plenum 145 includes a dome shaped upper wall as illustrated in FIG. 1, however, the centrally located treated air plenum 155 may have a height of about twice that of the lowermost treated air plenum 170 but not necessarily twice that of the uppermost treated air plenum 145. Also to accommodate the greater air flow into the centrally located treated air plenum 155 than the air flow into the uppermost treated air plenum 145 and the lowermost treated air plenum 170, the treated air outlet 180 of the centrally located treated air plenum 155 may have a greater cross-sectional area or diameter than that of the treated air outlet 175 of the uppermost treated air plenum 145 and/or the treated air outlet 185 of the lowermost treated air plenum 170, for example, a cross-sectional area or diameter of about twice that of the treated air outlet 175 of the uppermost treated air plenum 145 and/or the treated air outlet 185 of the lowermost treated air plenum 170.

The walls of the dry media beds of the vessel 100 may include sample ports CSP1-CSP12 with each of the dry media beds having three sample ports each at different heights, although in other embodiments different numbers of sample ports may be utilized. The sample ports CSP1-CSP12 may be utilized to take samples of gas passing through the media beds or of media from the media beds to analyze to determine the effectiveness of the contaminant removal performance of the media beds or to determine a contaminant saturation level of the media from the media beds to determine if a replacement of media is warranted or is coming close to being warranted.

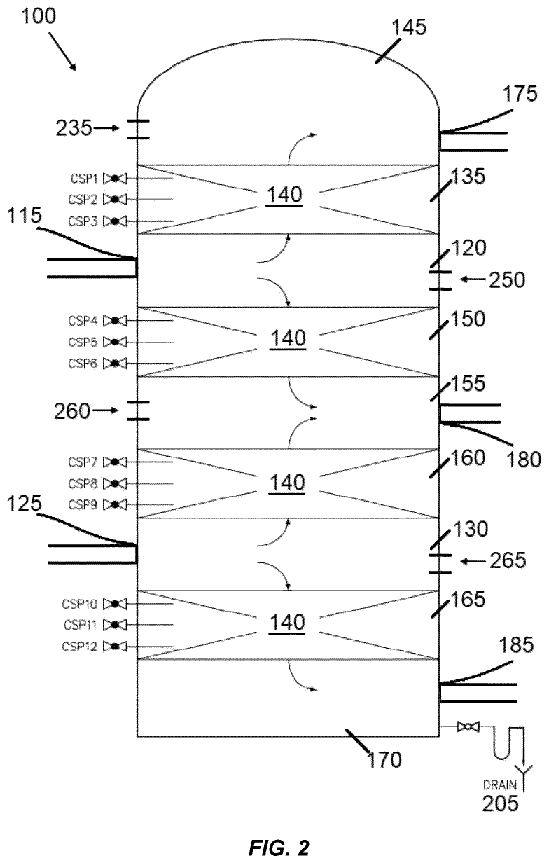

The vessel 100 may include access panels or ports through which used dry media 140 may be removed from each of the dry media beds 135, 150, 160, 165. As shown in FIG. 2, in which the external air manifolds 110, 190 have been omitted for clarity, access panels 235, 250, 260, 265 may be defined in an outer wall of the vessel above each respective one of the four vertically aligned dry media beds 135, 150, 160, 165 to provide for dry media 140 to be introduced into and removed from each respective one of the four vertically aligned dry media beds 135, 150, 160, 165. The access panels 235, 250, 260, 265 may open into each of the contaminated air plenums 120, 130 and treated air plenums 145, 155 and be offset from the respective air inlets 115, 125 and outlets 175, 180, 185 of the air plenums, optionally on opposite sides of the vessel 100 from the air inlets and outlets of each air plenum.

The vessel 100 may also include a drain 205 arranged to allow any liquid that has condensed or dripped down into the lowermost treated air plenum 170 to be removed.

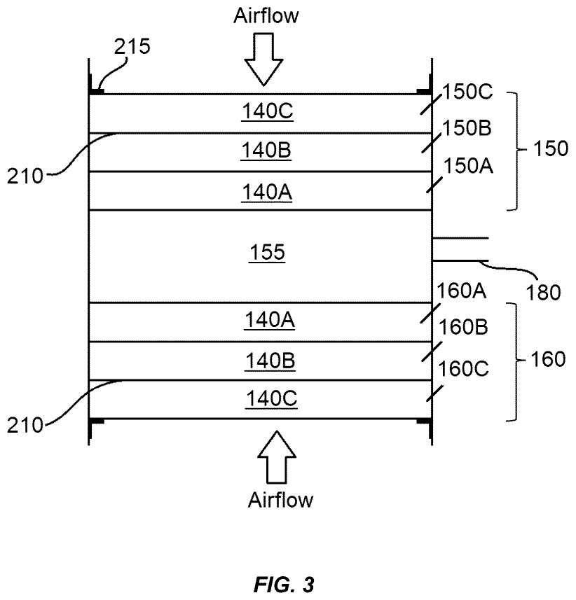

Each of the vertically aligned dry media beds 135, 150, 160, 165 may be divided into multiple vertically separated sub-beds by media bed separators 210, for example, screens with a mesh size smaller than the size of the dry media granules. There may be two or more sub-beds defined in each dry media bed. Different types of media may be disposed in each of the different sub-beds. The different sub-beds may be sized the same for each of the dry media beds. The different media types in each of the sub-beds may be arranged so that air flowing through each dry media bed passes through the different media types in the same order. FIG. 3 illustrates an example where dry media beds 150 and 160 are each divided into three sub beds 150A, 150B, and 150C and 160A, 160B, and 160C each including different types of dry media 140A, 140B, 140C.

As also shown in FIG. 3 ring baffles 215 may disposed on upstream ends of each of the four vertically aligned dry media beds adjacent outer sidewalls of the four vertically aligned dry media beds to help prevent air from channeling along walls of the media beds rather than through the media within the media beds.

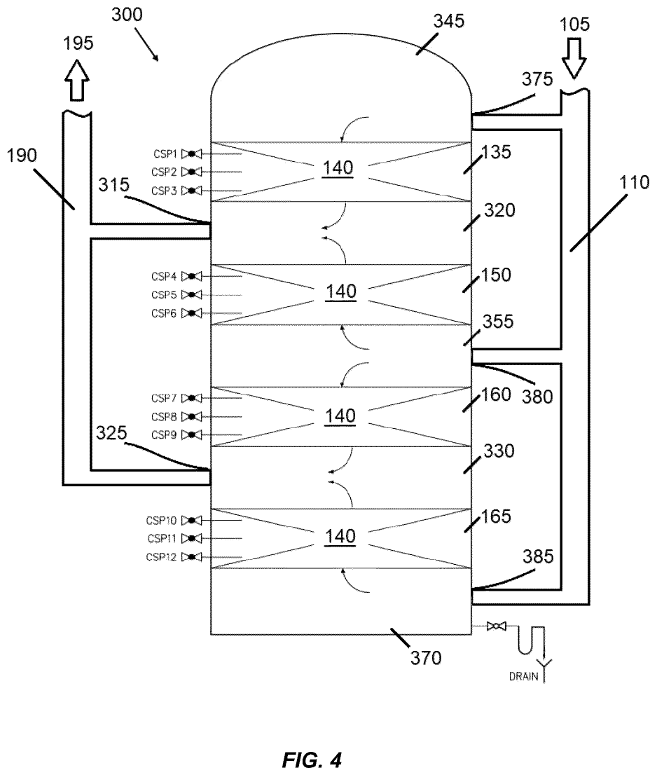

Air may also be fed through the vessel in the opposite direction to that described above. In such embodiments, what was the contaminated air manifold 110 in the previously described embodiment becomes the treated air manifold 190 and what was treated air manifold 190 becomes the contaminated air manifold 110. The contaminated air inlets 115, 125 of the previously described embodiment become treated air outlets 315, 325 and the treated air outlets 175, 180, 185 become contaminated air inlets 375, 380, 385. What were contaminated air plenums 120 and 130 in the prior embodiment become treated air plenums 320 and 330. What were treated air plenums 145, 155, and 170 in the prior embodiment become contaminated air plenums 345, 355, and 370. Air flow directions through the air plenums and media beds are reversed from the previous embodiment. An example of this second embodiment of such a quad bed dry media vessel 300 is illustrated in FIG. 4.

In the embodiment shown in FIG. 4 contaminated air 105 is provided to the vessel 300 from a contaminated air header 110. A first portion of the contaminated air 105 flows through a first or uppermost contaminated air inlet 375 into a first or upper (or uppermost) contaminated air plenum 345. A second portion of the contaminated air 105 flows through a second or centrally located contaminated air inlet 380 into a second or centrally located contaminated air plenum 355. A third portion of the contaminated air 105 flows through a third or lowermost contaminated air inlet 385 into a third or lowermost contaminated air plenum 370. Contaminated air 105 may flow through the three contaminated air inlets 375, 380, 385 and into the three contaminated air plenums 345, 355, 370 at the same or approximately the same rate which may be controlled by a fan pushing the contaminated air 105 through the contaminated air header 110 upstream of the vessel 300 and/or by a fan pulling treated air through a treated air manifold 190 downstream of the vessel 300 and/or by one or more valves (not shown for clarity) located in the contaminated air inlets 375, 380, 385.

Contaminated air 105 from the uppermost contaminated air plenum 345 passes through an uppermost one of the four vertically aligned dry media beds 135 in which one or more contaminants are removed from the contaminated air depending on the type of dry media 140 included in the dry media bed 135 to form treated air 195. The treated air 195 passes from the uppermost dry media bed 135 into an uppermost of the treated air plenums 320.

Contaminated air 105 from the centrally located contaminated air plenum 355 splits into two streams. One of the contaminated air streams from the centrally located contaminated air plenum 355 passes through a second highest one of the four vertically aligned dry media beds 150 to form treated air which flows from the second highest one of the dry media beds 150 into the uppermost of the treated air plenums 320. The second of the contaminated air streams from the centrally located contaminated air plenum 355 passes through a second to lowest one of the dry media beds 160 to form treated air which flows from the second to lowest one of the dry media beds 160 into a second to lowest one of the treated air plenums 330.

Contaminated air 105 from the lowermost contaminated air plenum 370 passes through a lowermost one of the four vertically aligned dry media beds 165 to form treated air 195. The treated air 195 passes from the lowermost dry media bed 165 into the second to lowest one of the treated air plenums 330.

The treated air 195 flows though outlets 315 and 325 positioned in the walls of the treated air plenums 320, 330 respectively, into a treated air manifold 190, from which it is released to the environment or sent to a further downstream treatment operation.

The upper treated air plenum 320 receives air from both the uppermost contaminated air plenum 345 and the centrally located contaminated air plenum 355 through the highest and second to highest dry media beds 135, 150 respectively. The lower treated air plenum 330 receives air from both the centrally located contaminated air plenum 355 and the lowermost contaminated air plenum 385 through the second to lowest and the lowest dry media beds 160, 165 respectively. Accordingly, both of the treated air plenums 320, 330 receive about the same amount of air as one another and may be sized similarly, for example, with the same or approximately the same heights.

The centrally located contaminated air plenum 355 supplies air to both the second highest and second lowest treated air plenums 320, 330, while the uppermost contaminated air plenum 345 supplies air to only the uppermost treated air plenum 320 and the lowermost contaminated air plenum 385 supplies air only to the lowermost treated air plenum 330. To accommodate this greater air flow the centrally located contaminated air plenum 355 may have a greater height than the uppermost contaminated air plenum 345 and/or the lowermost contaminated air plenum 370, for example, a height of a bout twice that of the uppermost treated air plenum 345 and/or the lowermost treated air plenum 370. In embodiments in which the uppermost contaminated air plenum 345 includes a dome shaped upper wall as illustrated in FIG. 4, however, the centrally located contaminated air plenum 355 may have a height of about twice that of the lowermost treated air plenum 370 but not necessarily twice that of the uppermost treated air plenum 345. Also to accommodate the greater air flow into the centrally located contaminated air plenum 355 than the air flow into the uppermost contaminated air plenum 345 and the lowermost contaminated air plenum 370, the contaminated air inlet 380 of the centrally located contaminated air plenum 355 may have a greater cross-sectional area or diameter than that of the contaminated air inlet 375 of the uppermost contaminated air plenum 345 and/or the contaminated air inlet 385 of the lowermost contaminated air plenum 370, for example, a cross-sectional area or diameter of about twice that of the contaminated air inlet 375 of the uppermost contaminated air plenum 345 and/or the contaminated air inlet 385 of the lowermost contaminated air plenum 370. The treated air outlets 315, 325 carry the same or about the same amount of airflow and may thus have similar or the same cross-sectional areas or diameters.

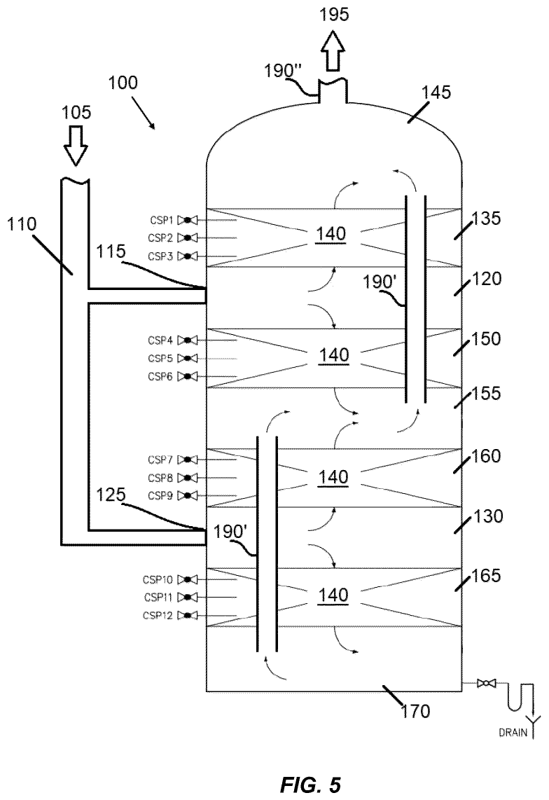

FIG. 5 illustrates an embodiment of a vertical flow quad bed dry media scrubber that includes internal stacks/air transfer ducts 190′. A lower of the internal stacks/air transfer ducts 190′ passes through dry media beds 160 and 165 and provides for treated air to move from the lowermost treated air plenum 170 to the second to the centrally located treated air plenum 155. An upper one of the internal stacks/air transfer ducts 190′ passes through dry media beds 135 and 150 and provides for treated air to move from centrally located treated air plenum 155 to the second to the uppermost treated air plenum 145. A single treated air outlet 190″ is provided in a wall of the uppermost treated air plenum. The internal stacks/air transfer ducts 190′ provide for treated air to flow from each of the treated air plenums 145, 155, 170 out of a single outlet 190″ and avoid the need for an external treated air manifold 190 and treated air outlets 175, 180, 185 positioned in the walls of the treated air plenums 145, 155, 170, respectively.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure, and are intended to be within the scope of the invention. Accordingly, the foregoing description and drawings are by way of example only.

What is claimed is:

1. A vertical flow dry media scrubber comprising:
four vertically aligned dry media beds;
a plurality of air plenums alternately disposed above and below each of the four vertically aligned dry media beds, the plurality of air plenums including:
at least two contaminated air plenums each including contaminated air inlets positioned in walls thereof, wherein the contaminated air inlets are positioned in the walls of a lowermost one of the at least two contaminated air plenums and an uppermost one of the at least two contaminated air plenums, respectively; and
at least two treated air plenums each including treated air outlets positioned in walls thereof, the at least two treated air plenums disposed on vertically opposite sides of one of the at least two contaminated air plenums, the at least two contaminated air plenums disposed on vertically opposite sides of one of the at least two treated air plenums, the treated air outlets positioned in the walls of a lowermost one of the at least two treated air plenums, an uppermost one of the at least two treated air plenums, and a centrally located one of the at least two treated air plenums, respectively.

2. The media scrubber of claim 1, further configured to direct contaminated air from a first of the contaminated air inlets through the uppermost one of the at least two contaminated air plenums and an uppermost one of the four vertically aligned dry media beds into the uppermost of the at least two treated air plenums as well as through the uppermost one of the at least two contaminated air plenums and a second to highest one of the four vertically aligned dry media beds into the centrally located one of the at least two treated air plenums.

3. The media scrubber of claim 2, configured to direct contaminated air from a second of the contaminated air inlets through the lowermost one of the at least two contaminated air plenums and a lowermost one of the four vertically aligned dry media beds into the lowermost one of the at least two treated air plenums as well as through the lowermost one of the at least two contaminated air plenums and a second to lowest one of the four vertically aligned dry media beds into the centrally located one of the at least two treated air plenums.

4. The media scrubber of claim 3, wherein the centrally located one of the at least two treated air plenums has a greater height than the lowermost one of the at least two treated air plenums.

5. The media scrubber of claim 3, wherein the treated air outlet positioned in the wall of centrally located one of the at least two treated air plenums has a greater cross-sectional area than each of the treated air outlet positioned in the wall of the lowermost one of the at least two treated air plenums and the treated air outlet positioned in the wall of the uppermost one of the at least two treated air plenums.

6. The media scrubber of claim 1, wherein each of the four vertically aligned dry media beds include screens defined in lower portions thereof, the screens configured to support and retain dry media within each of the four vertically aligned dry media beds.

7. The media scrubber of claim 1, further comprising ring baffles disposed on upstream ends of each of the four vertically aligned dry media beds adjacent outer sidewalls of the four vertically aligned dry media beds.

8. The media scrubber of claim 1, wherein the contaminated air inlets are fluidically coupled to a same contaminated air inlet header.

9. The media bed scrubber of claim 1, further comprising media bed separators disposed in each of the four vertically aligned dry media beds which separate each of the four vertically aligned dry media beds into at least two vertically separated sub-beds.

10. The media bed scrubber of claim 1, further comprising access panels defined in an outer wall of the media bed scrubber above each respective one of the four vertically aligned dry media beds, the access panels positioned and arranged to provide for dry media to be introduced into and removed from each respective one of the four vertically aligned dry media beds.

11. A method of removing one or more undesirable compounds from contaminated air, the method comprising:
introducing a first portion of the contaminated air into a first contaminated air plenum of a vertical flow dry media scrubber through a first contaminated air inlet at a pressure and velocity sufficient to pass contaminated air from the first contaminated air plenum through a first dry media bed into a first treated air plenum and to pass the contaminated air from the first contaminated air plenum through second dry media bed that is vertically displaced from the first dry media bed and into a second treated air plenum;
introducing a second portion of the contaminated air through a second contaminated air inlet into a second contaminated air plenum of the vertical flow dry media scrubber at a pressure and velocity sufficient to pass contaminated air from the second contaminated air plenum through a third dry media bed that is vertically displaced from the first and second dry media beds into a third treated air plenum that is vertically displaced from the first and second treated air plenums and to pass contaminated air from the second contaminated air plenum through a fourth dry media bed that is vertically displaced from the first, second, and third dry media beds and into the first treated air plenum, the first treated air plenum disposed between the first dry media bed and the fourth dry media bed; and
withdrawing treated air from the first, second, and third treated air plenums, treated air being withdrawn from the first treated air plenum at a flowrate of about twice a flowrate at which treated air is withdrawn from each of the second and third treated air plenums.

12. The method of claim 11, wherein the contaminated air is introduced into the first and second contaminated air plenums at a same flow rate.

13. The method of claim 11, wherein withdrawing treated air from the first, second, and third treated air plenums includes withdrawing treated air from the first treated air plenum through a treated air outlet having a greater cross-sectional area than treated air outlets through which treated air is withdrawn from either the second or third treated air plenum.

14. The method of claim 11, wherein passing the contaminated air through the first, second, third, and fourth dry media beds includes passing the contaminated air through a same media in each of the first, second, third, and fourth dry media beds.

15. The method of claim 11, wherein passing the contaminated air through the first, second, third, and fourth dry media beds includes passing the contaminated air through a first type of media and a second type of media in a same order in each of the first, second, third, and fourth dry media beds.

16. A method of removing at least one undesirable compound from contaminated air, the method comprising:
introducing a first portion of the contaminated air into a first contaminated air plenum of a vertical flow dry media scrubber through a first contaminated air inlet at a pressure and velocity sufficient to pass contaminated air from the first contaminated air plenum through a first dry media bed into a first treated air plenum;
introducing a second portion of the contaminated air into a second contaminated air plenum of the vertical flow dry media scrubber that is vertically displaced from the first contaminated air plenum through a second contaminated air inlet at a pressure and velocity sufficient to pass contaminated air from the second contaminated air plenum through a second dry media bed that is vertically displaced from the first dry media bed into the first treated air plenum and through a third dry media bed that is vertically displaced from the first and second dry media beds into a second treated air plenum; and
introducing a third portion of the contaminated air into a third contaminated air plenum of the vertical flow dry media scrubber that is vertically displaced from the first and second contaminated air plenums through a third contaminated air inlet at a pressure and velocity sufficient to pass contaminated air from the third contaminated air plenum through a fourth dry media bed that is vertically displaced from the first, second, and third dry media beds into the second treated air plenum, wherein the contaminated air is introduced into the second contaminated air plenum at a flow rate approximately twice that of a flow rate at which the contaminated air is introduced into either of the first and third contaminated air plenums.

17. A vertical flow dry media scrubber comprising:
four vertically aligned dry media beds;
a plurality of air plenums each alternately disposed above and below each of the four vertically aligned dry media beds, the plurality of air plenums including:
at least two contaminated air plenums each including contaminated air inlets positioned in walls thereof; and
at least two treated air plenums each including treated air outlets positioned in walls thereof, the at least two treated air plenums disposed on vertically opposite sides of one of the at least two contaminated air plenums, the at least two contaminated air plenums disposed on vertically opposite sides of one of the at least two treated air plenums.

18. A vertical flow dry media scrubber comprising:
four vertically aligned dry media beds;
a plurality of air plenums each alternately disposed above and below each of the four vertically aligned dry media beds, the plurality of air plenums including:
at least two contaminated air plenums each including contaminated air inlets positioned in walls thereof; and
at least two treated air plenums disposed on vertically opposite sides of one of the at least two contaminated air plenums, the at least two contaminated air plenums disposed on vertically opposite sides of one of the at least two treated air plenums; and
internal air transfer ducts passing through the four vertically aligned dry media beds and providing for flow of treated air between each of the at least two treated air plenums.

19. The media bed scrubber of claim 18, including a single treated air outlet defined in a wall of one of the at least two treated air plenums and in fluidic communication with each of the at least two treated air plenums.

20. The media bed scrubber of claim 18, wherein one of the internal air transfer ducts passes through two of the four vertically aligned dry media beds and provides for airflow between two of the at least two treated air plenums and a second of the internal air transfer ducts passes through two other of the four vertically aligned dry media beds and provides for airflow between two others of the at least two treated air plenums
